(19) United States
(12) Patent Application Publication
(10) Pub. No.: US 2020/0046013 A1
(43) Pub. Date: Feb. 13, 2020

(54) CONTROL UNIT, FOOD PRINTER AND METHOD FOR CONTROLLING A FOOD PRINTER

(71) Applicant: BSH HAUSGERAETE GMBH, MUENCHEN (DE)

(72) Inventors: LUCIA SCHUSTER, STUTTGART (DE); ROBERT KUEHN, BISCHOFSWERDA (DE); SEBASTIAN ERBE, KNITTLINGEN-FREUDENSTEIN (DE)

(21) Appl. No.: 16/343,052

(22) PCT Filed: Oct. 24, 2017
(86) PCT No.: PCT/EP2017/077058

§ 371 Date: Apr. 18, 2019

(30) Foreign Application Priority Data
Nov. 8, 2016 (DE) 10 2016 221 860.3

(51) Int. Cl. A23P 20/20; B33Y 30/00; B33Y 50/02

(52) U.S. Cl. CPC A23P 20/20; A23P 2020/253; B33Y 50/02; B33Y 30/00

(57) ABSTRACT

A control unit controls a food printer configured to extrude printing compound from a container onto a tray in order to print a food. The control unit is configured to determine spectral data relating to the printing compound in the container. The spectral data is dependent on a transmission degree and/or on a reflection degree of the printing compound for electromagnetic radiation of at least one wavelength. The control unit is furthermore configured to control the food printer in dependence on the spectral data. A food printer having the control unit and a method for controlling the printer are also provided.

The invention relates to a control unit, a food printer with such a control unit and a method for controlling such a food printer, in particular for printing a number of different printing compounds.

Food printers enable a user to individually and reliably prepare a plurality of different foods. For instance, different bakery products can be individualized and produced as required by means of a food printer.

Different printing compounds which are printed by a food printer and possibly cooked are required for different food. The different printing compounds may have different rheological properties, wherein the rheological properties can ii influence the printing process. Furthermore, a number of different printing compounds (with different rheological properties) are typically required for printing a (complex) food.

The present document is concerned with the technical object of providing a control unit, a food printer with such a control unit and a method for controlling a food printer, which enable food to be printed with different printing compounds in a reliable and precise manner.

The object is achieved by the subject matters of the independent claims in each instance. Advantageous preferred embodiments are defined, in particular, in the dependent claims, described in the description below or represented in the figures of the accompanying drawing. Preferred embodiments of the invention according to one of the categories control unit, food printer and method correspond, within the scope of the technically useful, possible and also preferred embodiments of the invention to the respective other categories, even when it is not indicated explicitly herein.

According to one aspect of the invention, a control unit is described accordingly for a food printer. The food printer is designed to extrude printing compound from a container onto a tray (e.g. a plate), in order to print a food. For this purpose, the food printer can comprise a printing head, which can be positioned with movement means (e.g. along one or more guide rails) to different positions above the tray. The container can be arranged (possibly replaceably) in the printing head and (edible, viscous) printing compound can be extruded at different positions from the container by means of a nozzle. A three-dimensional (3D) arrangement of printing compound can therefore be produced on the tray. The arrangement of printing compound can then possibly be cooked (e.g. baked) in a cooking compartment, in order to produce a food. The control unit can be designed to control the printing process (i.e. in particular the positioning of the printing head and/or the expulsion of printing compound from the container) (e.g. as a function of a 3D model of the food to be produced).

The control unit is designed to determine spectral data relating to the printing compound in the container. Here the spectral data depends on a transmission degree and/or on a reflection degree of the printing compound for electromagnetic radiation of at least one wavelength. In particular, the spectral data can indicate the transmission degree and/or the reflection degree of the printing compound for the electromagnetic radiation.

The food printer can comprise a spectral sensor, in particular a spectrometer, with a transmitter and a receiver. Here the transmitter can be designed to emit electromagnetic radiation (with at least one wavelength) in the direction of the container, and the receiver can be designed to capture electromagnetic radiation which has been reflected by or in the container and/or which has run through the container. In particular, the portion of the emitted electromagnetic radiation which has been reflected in the container (in particular by printing compound in the container) and/or has run through the container can be received or captured by the receiver. The control unit can then be designed to determine the spectral data on the basis of a property of the electromagnetic radiation emitted and received. The property can comprise e.g. the energy of the electromagnetic radiation for a specific wavelength. The determination of the spectral data can then comprise the determination of a quotient from the energy of the received radiation and the energy of the transmitted radiation. For instance, the transmission degree and/or the reflection degree can be determined. The spectral data can be determined for a plurality of different wavelengths.

The control unit is further designed to control the food printer as a function of the spectral data. In particular, a property of the printing compound in the container can be determined on the basis of the spectral data (e.g. a flow property or a rheological property of the printing compound). A printing parameter of the food printer (e.g. the pressure with which the printing compound is driven out of the container) can then be adjusted as a function of the determined property of the printing compound. Taking spectral data into consideration therefore enables the quality of a food printing process to be increased. In particular, the printing process can be adjusted efficiently and reliably to different printing compounds (with different rheological properties).

The container can comprise a first printing compound (with a first viscosity) and a second printing compound (with a second viscosity). The control unit can be designed to detect a transition between the first printing compound and the second printing compound on the basis of the spectral data. The control unit can then be designed to adjust one or more printing parameters of the food printer with the transition or for the transition from the first printing compound to the second printing compound. In particular, one or more printing parameters can be adjusted, if, instead of the first printing compound, the second printing compound is to be extruded from the container. A number of printing compounds or components of a food can therefore be provided (sequentially or one behind the other) in a container and reliably processed. A multi-component print for food can therefore be enabled in a reliable and user-friendly manner.

The container can comprise a separating agent between the first printing compound and the second printing compound, wherein the separating agent has a specific, spectral property. The spectral property may be known to the control unit previously. The separating agent may be tasteless. Furthermore, the quantity of separating agent between the printing compounds (in terms of volume) can be smaller than the quantities of the printing compounds by one or more orders of magnitude. The separating agent may therefore be substantially irrelevant to the food produced. The separating agent can be used in particular solely for the signaling of a transition between two different printing compounds. The control unit can be designed to detect the transition between the first printing compound and the second printing compound on the basis of the spectral data and on the basis of the specific spectral property of the separating agent. The multi-component printing of a food can be further improved by using a separating agent.

The control unit can be designed to adjust one or more printing parameters of the food printer as a function of the spectral data. The one or more printing parameters here may comprise: a speed and/or a pressure, with which the printing compound is extruded from the container; a position (in particular along x- and/or y-coordinates) of the tray, on which printing compound is extruded from the container and/or a height (in particular along a z-coordinate) above the tray, from which printing compound is extruded from the container.

Within the scope of determining the spectral data relating to the printing compound, (possibly predetermined) spectral properties (in particular a transmission degree) of the container can be taken into account. It can thus be ensured that the spectral data (only) depends on the properties of the printing compound. The container is preferably embodied such that the container for the electromagnetic radiation used by the spectral sensor (at least in a local region used for the measurement) has a transmission degree, which is greater than a transmission threshold value (e.g. of 80%, 90% or more).

The spectral data can depend on the transmission degree and/or on the reflection degree of the printing compound for electromagnetic radiation in a wavelength range with a plurality of different wavelengths. In particular, the spectral data can indicate a transmission and/or reflection spectrum for the printing compound. The control unit can then be designed to determine an ingredient of the printing compound on the basis of the spectral data. The knowledge with respect to the ingredient can then be taken into consideration when the food printer is controlled.

The container can comprise identification means (e.g. a machine-readable code and/or an RFID tag), wherein the identification means indicates identification data relating to the printing compound in the container. The control unit can be designed to control the food printer (also) as a function of the identification data. For instance, the identification data can indicate printing parameters which are to be used for different printing compounds in a container. Furthermore, a transition between the different printing compounds can be detected on the basis of the spectral data. The required printing parameters can therefore be determined precisely at any point in time on the basis of the spectral data and on the basis of the identification data. A high-quality multi-component printing is therefore enabled.

The control unit can be designed to adjust a property of the electromagnetic radiation, which is used to determine the spectral data, as a function of the identification data. For instance, the identification data can indicate which one or more wavelengths is/are to be used to determine the spectral data. The spectral sensor of the food sensor can then be adjusted accordingly. The quality of the captured spectral data and therefore the quality of the printed food can therefore be increased.

The control unit can be designed to determine target spectral data on the basis of the identification data. The target spectral data can then be compared with the spectral data and an indication (e.g. an indication of a malfunction of the spectral sensor) can be output to a user of the food printer as a function of the comparison. A reliable food print can therefore be enabled.

The food printer can comprise a pyrometer, which is designed to capture temperature data relating to a temperature of the container and/or the printing compound. In particular, the use of a pyrometer enables the contactless capture of temperature data. Here the afore-cited identification data can indicate characteristic data (for the printing compound and/or for the container) which enable the heat radiation captured with a pyrometer to be converted into a temperature of the container and/or the printing compound. The control unit can be designed to control the food printer (also) as a function of the temperature data. In particular, one or more printing parameters can be adjusted as a function of the temperature data. Alternatively, a tempering unit of the food printer can be activated in order to change the temperature of the container and/or of the printing compound (e.g. to a target printing temperature). The print quality can therefore be increased further.

According to a further aspect of the invention, a food printer for printing a food on a tray is described. The food printer comprises a printing head with a container for receiving printing compound. Moreover, the food printer comprises a sensor for capturing spectral data relating to the printing compound in the container. Furthermore, the food printer comprises the control unit described in this document.

According to a further aspect of the invention, a method for controlling a food printer is described. The food printer is designed to extrude printing compound from a container onto a tray (e.g. a plate), in order to print a food. The method comprises determining spectral data relating to the printing compound in the container. Here the spectral data depends on a transmission degree and/or on a reflection degree of the printing compound for electromagnetic radiation with at least one wavelength. The method further comprises controlling the food printer as a function of the spectral data.

It should be noted that each aspect of the control unit or method described in this document can be combined with one another in a variety of ways. In particular, the features of the claims can be combined with one another in a variety of ways.

Furthermore, the invention will be described in greater detail making reference to the preferred exemplary embodiments illustrated in the appended drawings. In the drawings:

FIG. 1 shows a block diagram of a system for producing a food;

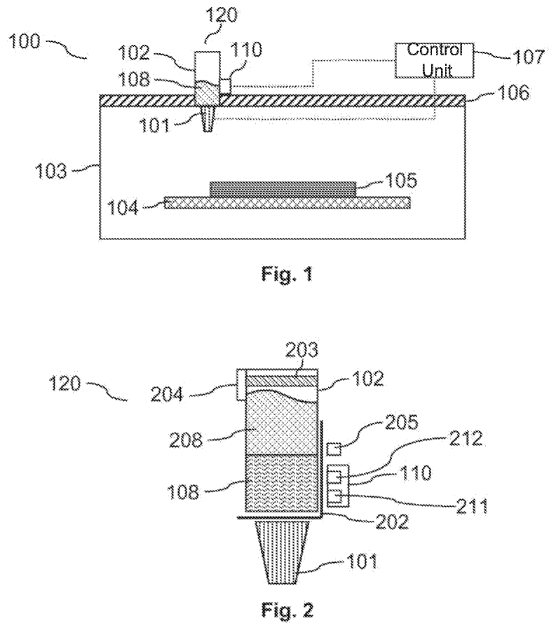

FIG. 2 shows a block diagram of an exemplary printing head;

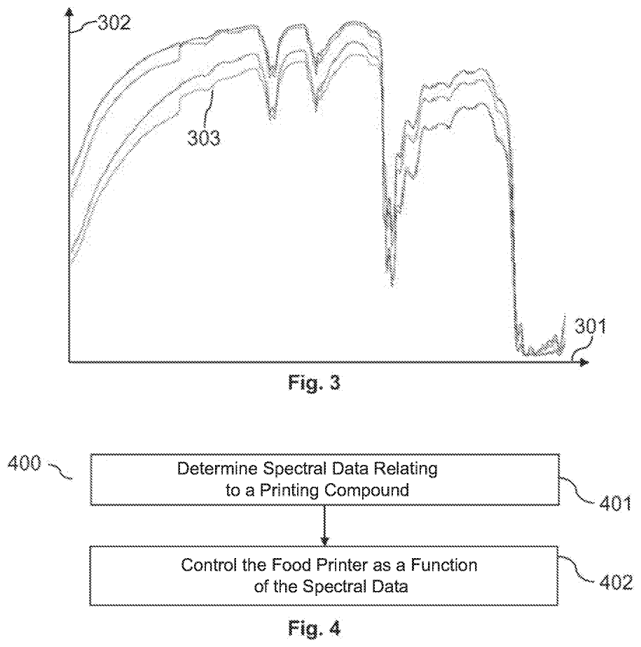

FIG. 3 shows exemplary spectral properties of a container; and

FIG. 4 shows a flow chart of an exemplary method for controlling a food printer.

As shown in the introduction, the present document is concerned with the reliable processing of different printing compounds in a food printer. In this context, FIG. 1 shows a block diagram of an exemplary food printer 100. The food printer 100 comprises a printing head 120, which can be positioned using movement means 106 (e.g. along a rail 106) at different points above a printing surface or tray 104. The printing head 120 can be activated by a control unit 107 of the printer 100.

The control unit 107 can determine a 3D model of a food 105 to be printed. Furthermore, the control unit 107 can activate the printing head 120 and the movement means 106 as a function of the 3D model in order to print a food 105 on the tray 104 which has a form corresponding to the 3D model. For this purpose, the movement means 106 can be designed to move the printing head 120 parallel above the tray 104 (i.e. in the X and Y direction and/or in another coordinate system, such as e.g. a polar coordinate system with a radial direction and an angular direction). Furthermore, the movement means 106 can be designed to change the distance between the printing head 120 and the tray 104 (i.e. to move the printing head 120 in the Z-direction).

The tray 104 can be arranged in a cooking compartment 103 (e.g. in an oven). The control unit 107 can be designed to control a cooking process of the food 105 in the cooking compartment 103. In particular, a temperature of the cooking compartment 103 can be controlled, e.g. in order to bake a food 105 and/or in order to cool a food 105.

The printing head 120 comprises (as shown in FIG. 2) a printing compound container 102 for receiving printing compound 108, 208. The printing compound container 102 can comprise a (replaceable) cartridge or casing, for instance. The container 102 can be embodied to receive a number of different printing compounds 108, 208 or different types of printing compound. The container 102 shown in FIG. 2 comprises a first printing compound 108 (e.g. a dough) and a second printing compound 208 (e.g. tomato sauce). Different printing compounds 108, 208 can be separated from one another using a separating layer with a separating agent. In particular, a separating layer causes directly adjacent printing compounds 108, 208 in a container 102 not to mix (substantially) with one another. Furthermore, the separating agent can have properties which enable the transition between two different printing compounds 108, 208 to be reliably captured using sensors.

The printing head 120 comprises a nozzle 101 (e.g. a nozzle needle), by way of which printing compound 108, 208 can be extruded from the container 102 and printed onto the tray 104. Furthermore, the printing head 120 typically comprises printing means 203 (e.g. a movable stamp within the container 102), with which printing compound 108, 208 can be pressed or printed out of the container 102 by way of the nozzle 101. The printing means 203 can be activated by the control unit 107 (as a function of the 3D model) in order to print a food item 105.

The parameters for the activation of the printing means 203 typically depend on one or more properties, in particular on one or more rheological properties, of the printing compound 108, 208 to be extruded. For instance, the pressure which has to be applied by the printing means 203 in order to press a certain quantity of printing compound 108, 208 out of the nozzle 101 typically increases with a reducing viscosity of the printing compound 108, 208. In order to produce a high-quality food 105, it is therefore advantageous if one or more properties of the printing compound 105 to be printed are known, and can be taken into account in the printing process (particularly when defining the printing parameters of the printing process).

Particularly with containers 102 filled industrially and/or commercially, which can be purchased by a user in a grocer's shop, for instance, identification means 204 can be provided on the container 102, which indicate information relating to the one or more printing compounds 108, 208, which are disposed in the container 102. The identification means 204 may comprise for instance a machine-readable code (e.g. a barcode or a QR code) and/or an RFID tag. The printer 100 can have sensor means (not shown) which are designed to capture identification data relating to the identification means 204 of a container 102. The control unit 107 can determine one or more properties of the one or more printing compounds 108, 208 in the container 102 on the basis of the captured identification data. In particular, the control unit 107 can activate the printing head 120 (in particular the printing means 203) on the basis of the captured identification data.

The rheological properties of a printing compound 108, 208 are typically also dependent on the temperature of the printing compound 108, 208. The printing head 120 can have a temperature sensor 205 (in particular a pyrometer), with which temperature data relating to the temperature of the one or more printing compounds 108, 208 in a container 102 can be captured. The temperature sensor 205 can be designed to capture the temperature data in a contact-free manner. The temperature sensor 205 can be arranged on a support structure 202 of the printing head 120. The support structure 202 can be designed to receive different containers 102 interchangeably (possibly with an integrated nozzle 101 in each case). The control unit 107 can be designed to activate the printing head 120 (in particular the printing means 203) on the basis of the captured temperature data.

If a container 102 has no identification means 204 (e.g. because the container 102 has been filled with printing compound 108, 208 by a user him/herself) and/or if a container 102 has a number of different printing compounds 108, 208 with different rheological properties, the printing parameters for activating a printing head 120 can possibly not be determined with sufficient accuracy, which may have a negative effect on the quality of the printed food 105. For instance, information relating to the different printing compounds 108, 208 can be provided by the identification means 204 of a container 102. On the other hand, the identification means 204 cannot indicate the boundary between two different printing compounds 108, 208 with sufficient accuracy.

The printing head 120 can comprise a spectral sensor 110 (e.g. a spectrometer), which is designed to capture spectral data relating to at least one printing compound 108, 208 in a container 102. The spectral sensor 110 can be arranged on the support structure 202 of the printing head 110, in particular directly on the nozzle 101. The spectral sensor 110 comprises a transmitter 211, which is designed to emit electromagnetic radiation in the direction of the container 102. The transmitter 211 can comprise a light source, a laser, an LED, etc., for instance. The spectral sensor 110 further comprises a receiver 212, which is designed to receive electromagnetic radiation which is reflected on and/or in the container 102. One or more properties of the printing compound 108, 208 can then be determined in the container 102 on the basis of the emitted radiation and the reflected radiation (i.e. on the basis of the spectral data).

The container 102 has at least one region, in which the container 102 for the ii emitted and reflected radiation is at least partially transparent. In particular, at least in one region (e.g. within a window), the container 102 can have a transmission degree for the emitted and reflected radiation, which is greater than a transmission threshold value (e.g. of 80%, 90% or more). This can ensure that the spectral data indicates information with respect to printing compounds 108, 208 within the container 102. The transmission degree of the container 102 can be taken into account when the captured spectral data is evaluated. Information relating to the printing compound 108, 208 within a container 102 can therefore be determined precisely.

The control unit 107 can be designed to activate the printing head 120 and/or the movement means 106 also as a function of the spectral data. A food 105 can be printed from different printing compounds 108, 208 in a reliable and precise manner.

With the measures described in this document, information relating to the contents of a container 102 (especially with a multi-component filling) for a 3D food printer 100 can be determined using one or more contact-free measuring methods. Here the temperature of the container 102 used can also be measured in a contact-free manner.

For instance, when a container 102 is filled with multiple components, the fill quantities of individual printing compounds or components 108, 208 can be subjected to certain tolerances, so that the component transition between adjacent components 108, 208 varies between different containers or cartridges 102. This may result in errors in the print template (i.e. in the food 105 produced). With the measuring method described in this document, a component transition can be detected precisely (particularly on the basis of the spectral data).

The printing head 120 can, as shown above, comprise a sensor 110 based on spectroscopy, with which certain material properties of the printing medium 108, 208 (i.e. a printing compound) can be determined. In the process the sensor 110 can be adjusted to properties of the container 102 used, in particular to the ii material (e.g. polypropylene) of the container 102. FIG. 3 shows exemplary transmission spectra 303 (which indicate the transmission degree 302 as a function of the wavelength 301) for different containers 102. The sensor 110 can be designed to emit and receive electromagnetic radiation in a wavelength range, in which the container 102 has a relatively high transmission degree 302. Furthermore, the control unit 107 can be designed to take into account the transmission spectrum 303 of a container 102 when the spectral data captured by the sensor 110 is evaluated. The container 102 can have at least one region (e.g. a clear-view window) with a relatively high transmission degree 302 in the wavelength range of the sensor 110.

Exemplary wavelength ranges for determining material properties of a printing medium 108, 208 are UV (ultraviolet), VIS (radiation in the visible range), NIR (near infrared), MIR (mid infrared), LIR (far infrared). A wavelength range which is suited hereto can be selected depending on the measurement requirement and information needs of the printer 100 with respect to the printing medium 108, 208. A wavelength range from the VIS and NIR can preferably be used. If e.g. a color difference between different components 108, 208 is to be detected in a container 102, a sensor 110 (in particular a receiver 212) can then be used for the VIS range.

The sensor 110 comprises a transmitter (e.g. a light source) 211, which is matched to the detector or receiver 212 of the sensor 110. The transmitter 211 and receiver 212 can be in connection with one another in an optical axle and have a shared focus. The sensor 110 is preferably arranged close to (i.e. directly on) the container 102, in order to reduce incorrect measurements (e.g. as a result of disturbance variables such as external radiation). Furthermore, the sensor 110 is preferably arranged in the immediate vicinity of the exit of the container 102 (i.e. on the nozzle 101).

The sensor 110 can be designed to determine spectral data (e.g. a reflection degree) for one or more wavelengths 301 or for a wavelength range. In particular, if no information means 204 are arranged on the container 102 and/or less information about the printing medium 108, 208 used is known, a complete spectrum (wideband e.g. in the VIS, NIR and/or IR range) can be captured. Here the available information relating to the printing medium 108, 208 increases with an increasing bandwidth and resolution of the captured spectrum. For instance, individual ingredients of a printing medium 108, 208 can possibly be determined (particularly on the basis of a spectrum in the IR range).

The encoding 204 provided on an industrially produced and filled container 102 typically shows information relating to the contents of the container 102, optical properties of the contents of the container 102, a material from which the container 102 is produced, printing parameters for the printing process and/or a best before date. If information of this type is available, the wavelength range of the sensor 110 can be reduced to one or just a few wavelengths (e.g. in the VIS range). A cost-efficient sensor 110 can therefore be used. The control unit 107 can determine, on the basis of the identification data indicated by the information means 204, how the sensor 110 is to be operated, in order to identify a component transition between two printing compounds 108, 208 in a container 102.

The printer 100 can enable a contact-free temperature measurement of the container 102. In particular, a pyrometer 205 (e.g. a thermopile) can be provided (e.g. as part of the sensor 110). The emission degree required to accurately measure the temperature can be determined on the basis of the information indicated by the information means 204 (i.e. characteristic data relating to the container 102 and/or relating to the one or more printing compounds 108, 208 can be provided). A precise, contact-free measurement of the temperature can therefore be enabled. The measured temperature of the container 102 can be used to adjust the printing parameters. Furthermore, the temperature data can be used to control or regulate a tempering of the container 102 to a specific target printing temperature.

The control unit 107 can be designed to detect a contamination of the sensor 110 and/or container 102 on the basis of the identification data and on the basis of the spectral data. In particular, it is possible to identify that the spectral data does not match with target spectral data, which is indicated by the identification means 204 on the container 102. Application/system errors can therefore be reduced or avoided.

The printing process can be individually matched to the properties of the respective printing medium 108, 208 on the basis of the spectral data. It is therefore possible to adjust (e.g. regulate) the printing parameters (e.g. printing speed, material advance, printing geometry, layer distance, etc.) as a function of the printing medium 108, 208 and possibly its temperature. Cleaner and repeatable printing results can therefore be achieved.

For instance, a pizza which consists of two components 108, 208 can be printed. These two components 108, 208 are firstly the base (dough) and secondly the topping (tomato sauce). Both components 108, 208 can be disposed together in one cartridge 102. Both components 108, 208 have different rheological properties, which are in turn temperature-dependent. In order to layer both components 108, 208 one on top of the other (tomato sauce on dough), two different levels can be printed by the printer 100.

The transition between the two components 108, 208 can vary (particularly with a cartridge 102, which has been filled by a user). The transition between the two components 108, 208 can however be reliably detected with the aid of the spectral data. The control unit 107 can then adjust the printing parameters and/or the printing geometry as a function of the spectral data. The tomato sauce can therefore be placed reliably on the dough.

The reliability of the printer 100 can be increased by taking into account information means 204 of a container 102. The information means 204 can indicate for instance information relating to casing material, casing content, number of components 108, 208, series and/or layering (in series or parallel) of the components 108, 208. The printer 100 can therefore reliably determine which components 108, 208 are to be expected with which (optical or spectral) properties. The costs of a spectral sensor 110 can therefore be reduced and/or the quality of the evaluation of the spectral data can be increased.

In particular, when an automatic refill is carried out by a user, a phase separating agent (liquid or paste-like) can be used to enable as clear a transition as possible between components 108, 208. The phase separating agent can form a phase limit here. The phase separating agent can have specific optical or spectral properties, which can be detected by the sensor 110 in order to signal a component transition to the printer 100. A component transition can therefore be reliably detected even without knowledge of the optical properties of the individual components 108, 208.

FIG. 4 shows a flow chart of an exemplary method 400 for controlling a food printer 100. The food printer 100 is designed to extrude printing compound 108, 208 from a container 102 onto a tray 104 in order to print a food 105. The method 400 can be carried out by a control unit 107 of the food printer 100, for instance. The method 400 comprises determining 401 spectral data relating to the printing compound 108, 208 in the container 102. Here the spectral data depends on a transmission degree and/or on a reflection degree of the printing compound 108, 208 for electromagnetic radiation. In particular, the spectral data can indicate the transmission and/or reflection spectrum. Moreover, the method 400 comprises controlling 402 the food printer 100 as a function of the spectral data.

On the basis of the measures described in this document, the properties of one or more printing compounds 108, 208 in a container can be reliably determined in order to be able to print high-quality food 105. In particular, it is possible to identify whether a container is empty and/or whether an unknown container 102 has been inserted into the printing head 120. Moreover, it is possible to identify whether an industrially filled and known container, which has already been emptied, has been refilled and inserted by a user, and/or whether a partially emptied container, is reinserted (in this case a fill level can possibly be stored and recalled again if necessary). Furthermore, transitions between printing compounds 108, 208 can be reliably identified, which enables a high-quality multi-component food printing. Moreover, printing parameters can be adjusted precisely to properties of the respective printing compound 108, 208.

The present invention is not restricted to the exemplary embodiments shown. It should in particular be noted that the description and the figures are only to illustrate the principle of the proposed printer 100, the proposed control unit 107 and/or the proposed method 400.

1-12. (canceled).

13. In a food printer configured to extrude printing compound from a container onto a tray in order to print a food, a control unit configured:
to determine spectral data relating to the printing compound in the container, the spectral data being dependent on at least one of a transmission degree or a reflection degree of the printing compound for electromagnetic radiation of at least one wavelength; and
to control the food printer as a function of the spectral data.

14. The control unit according to claim 13, wherein:
the control unit is configured to determine the spectral data based on a property of electromagnetic radiation emitted by a transmitter of a spectral sensor of the food printer in a direction of the container and received by a receiver of the spectral sensor configured to capture electromagnetic radiation having been reflected by the container.

15. . The control unit according to claim 14, wherein the spectral sensor is a spectrometer, and the receiver is configured to capture electromagnetic radiation having been reflected by the printing compound being at least one of disposed in or run through the container.

16. The control unit according to claim 13, wherein:
the control unit is configured to detect a transition between a first printing compound and a second printing compound in the container based on the spectral data; and
the control unit is configured to adjust one or more printing parameters of the food printer based on the transition from the first printing compound to the second printing compound.

17. The control unit according to claim 16, wherein:
the control unit is configured to detect the transition between the first printing compound and the second printing compound based on the spectral data and based on a specific spectral property of a separating agent disposed in the container between the first printing compound and the second printing compound.

18. The control unit according to claim 13, wherein:
the control unit is configured to adjust one or more printing parameters of the food printer as a function of the spectral data; and
the one or more printing parameters include at least one of:
a speed at which the printing compound is extruded from the container, or
a pressure with which the printing compound is extruded from the container, or
a position of the tray on which printing compound is extruded from the container, or
a height above the tray from which the printing compound is extruded from the container.

19. The control unit according to claim 13, wherein:
the spectral data depends on at least one of the transmission degree or the reflection degree of the printing compound for electromagnetic radiation in a wavelength range with a plurality of different wavelengths; and
the control unit is configured to determine an ingredient of the printing compound based on the spectral data.

20. The control unit according to claim 13, wherein:
the control unit is configured to control the food printer as a function of identification data relating to the printing compound in the container and indicated by an identification device of the container.

21. The control unit according to claim 20, wherein the control unit is configured to adjust a property of the electromagnetic radiation used to determine the spectral data, as a function of the identification data.

22. The control unit according to claim 20, wherein the control unit is configured:
to determine target spectral data based on the identification data;
to compare the target spectral data with the spectral data; and
to output a notification to a user of the food printer as a function of the comparison.

23. The control unit according to claim 13, wherein:
the control unit is configured to control the food printer as a function of temperature data relating to a temperature of at least one of the container or the printing compound and detected by a pyrometer of the food printer.

24. A food printer for printing a food on a tray, the food printer comprising:
a printing head having a container for receiving printing compound;
a sensor for capturing spectral data relating to the printing compound in said container; and
a control unit according to claim 13.

25. A method for controlling a food printer configured to extrude printing compound from a container onto a tray in order to print a food, the method comprising the following steps:
determining spectral data relating to the printing compound in the container, the spectral data being dependent on at least one of a transmission degree or a reflection degree of the printing compound for electromagnetic radiation with at least one wavelength; and
controlling the food printer as a function of the spectral data.
